(19) United States
(12) Patent Application Publication
(10) Pub. No.: US 2026/0059468 A1
(43) Pub. Date: Feb. 26, 2026

(54) STEERING OF ROAMING TECHNIQUES IN A COMMUNICATION SYSTEM

(71) Applicant: GOOGLE LLC, Mountain View, CA (US)

(72) Inventor: Ching-Yu Liao, Mountain View, CA (US)

(21) Appl. No.: 19/100,349

(22) PCT Filed: Jul. 31, 2023
(86) PCT No.: PCT/US2023/029147

§ 371 Date: Jan. 31, 2025

Related U.S. Application Data
(60) Provisional application No. 63/393,969, filed on Jul. 31, 2022.

(51) Int. Cl. H04W 60/04; H04W 48/02; H04W 84/04

(52) U.S. Cl. CPC H04W 60/04; H04W 48/02; H04W 84/042

(57) ABSTRACT

A node in a core network (CN) of a Public Land Mobile Network (PLMN) supports steering of roaming (SOR). The node receives (220) an indication of a registration attempt by a roaming UE for which the PLMN operates as a home PLMN (HPLMN), the registration attempt occurring at a visitor PLMN (VPLMN). The node obtains (242, 232), from an entity configured to provide SOR information of the CN, SOR information related to the registration attempt; determines (250), based at least on the received response and an operator policy related to the UE and the VPLMN, whether to accept or reject the registration attempt; and provides (260), to the VPLMN, a result of the determining.

### CROSS-REFERENCE TO RELATED APPLICATION

This application claims priority to and the benefit of the filing date of provisional U.S. patent application Ser. No. 63/393,969 entitled “Steering of Roaming Techniques in a Communication System,” filed on Jul. 31, 2022. The entire contents of the provisional application are hereby expressly incorporated herein by reference.

### FIELD OF THE DISCLOSURE

This disclosure relates generally to wireless communications and, more particularly, to supporting services related to roaming.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In a telecommunication system, the profile of a user equipment (UE) resides in a Home Public Land Mobile Network (HPLMN). A PLMN generally includes a core network (CN) in which multiple nodes support such services as voice calls, short message services (SMS), IP multimedia services (IMS), etc., and a radio access network (RAN) in which base stations support a radio interface with UEs. Each PLMN typically is associated with a different mobile network operator.

The UE generally selects a PLMN upon power-up or when returning from an arca of no cellular coverage. Because an HPLMN generally does not cover the entire geographic area in which the UE can operate, the UE in some cases temporarily registers with, or “roams” to, another PLMN. The PLMN with which a UE is currently registered is referred to as a visitor PLMN (VPLMN).

The Global System for Mobile Communications Association (GSMA) has proposed that PLMNs support Roaming Value Added Services (RVAS) such as Welcome SMS to provide a UE with information regarding the network in which UE has registered, pricing information for certain services, country information, etc.; international mobile subscriber identity (IMSI) based routing to a particular core network; and Steering of Roaming (SOR), which generally refers to the ability of an HPLMN to exercise a certain amount of control over the choice of a VPLMN for a roaming UE. A PLMN can provide RVAS directly or outsource RVAS to a fully trusted entity, which can operate as an RVAS provider, an Internetwork Packet Exchange (IPX) provider, or a roaming hub provider (i.e., a provider of central points, or hubs, for exchanging roaming agreements.

Second-, third-, and fourth-generation telecommunication networks can support RVAS using proprietary techniques. These techniques can involve intercepting location update and registration signaling over the roaming interface between an HPLMN and a VPLMN, and sending an appropriate rejection cause to a UE, so as to direct the UE to attempt the selecting of a different VPLMN. However, changes in network topology and protocols in fifth-generation (5G) networks effectively prevent third-party providers from offering RVAS in the same manner in 5G networks. For instance, a Home Security Edge Protection Proxy (H-SEPP) of an HPLMN and a Visitor Security Edge Protection Proxy (V-SEPP) of a VPLM now encrypt signaling in a way that prevents an IPX from spoofing location update/registration signaling (as illustrated in FIG. 1). Moreover, the existing 3rd Generation Partnership Project (3GPP) service requirements do not cover some of the RVAS use cases.

For this reason, the 3GPP has proposed that RVAS, and SOR functionality in particular, conform to standardized mechanisms. The standardized 5GS SOR mechanism allows an HPLMN to request that a UE automatically find and register on a VPLMN different from the one the UE has found, when another VPLMN is available and is not on the Forbidden List. A PLMN operator or a third-party RVAS provider can operate an SOR application function (SOR-AF), which can provide SOR information for steering a UE during registration, after registration, or in a connected mode. The SOR information can include a list of preferred PLMN/access technology combinations, SOR connected-mode control information (SOR-CMCI) along with a corresponding indicator, an SOR standalone non-public network (SNPN) selection information (SOR-SNPN-SI), and/or a secured packet. A Unified Data Management node (UDM) then sends SOR information to the UE over N1 non-access stratum (NAS) signaling, to facilitate PLMN selection. Further, the 3GPP has proposed that the SOR-AF subscribe to notifications from HPLM UDM related to changes of the roaming status of the UE.

However, multiple procedures related to SOR-AF, messaging between a PLMN and SOR-AF, application programming interfaces (APIs) related to SOR, remain unclear.

### SUMMARY

The techniques of this disclosure generally pertain to SOR during the registration procedure or after the registration procedure. More specifically, these techniques allow a PLMN to determine whether to accept or reject a registration attempt of a UE, and whether to direct the UE to search for another network. These techniques further allow a roaming UE to access services when a suitable VPLMN exists. Still further, these techniques allow a PLMN to select and apply the relevant SOR information consistent with certain validity criteria.

According to one example technique, a UDM (or another suitable node in an HPLMN) obtains SOR information for a UE attempting to register at a VPLMN. The UDM can obtain this information from an SOR-AF via a Network Exposure Function (NEF). The UDM then determines whether to allow the UE to register with the VPLMN or reject the registration attempt, and sends a rejection cause (or, in some cases, an acceptance cause) to the UE.

In some cases, the UDM provides further guidance to the UE with respect to future registration attempts with the VPLMN, e.g., to temporarily rather than permanently prevent the UE from attempting to register with the VPLMN. In this manner, the UDM and the NEF can cause the UE to receive a proper rejection cause that causes the UE to select another VPLMN and avoid, when other VPLMNs are available, the no-service scenario. Moreover, this redirection mechanism can be compatible with the mechanisms that rely on proprietary interfaces with the SOR-AF.

In some implementations, the techniques of this disclosure are compatible with the redirection mechanisms uses in 4G networks, and allows the redirection mechanism to correctly operate with a legacy SOR mechanism, without creating no-service scenarios for a UE for which the rejected VPLMN is the only available VPLMN.

An example embodiment of these techniques is a method for supporting steering of SOR, implemented in a node of a core network CN of a PLMN. The method includes receiving an indication of a registration attempt by a roaming UE for which the PLMN operates as an HPLMN, the registration attempt occurring at a VPLMN. The method further includes obtaining, from an entity configured to provide SOR information of the CN, SOR information related to the registration attempt; determining, based at least on the received response, whether to accept or reject the registration attempt; and providing, to the VPLMN, a result of the determining.

Another example embodiment of these techniques is a network node comprising processing hardware and configured to implement the method above.

Still another example embodiment of these techniques is a method in a UE associated with an HPLMN for registering with a VPLMN. The method comprises transmitting, to the VPLMN, a registration request; receiving, via the PLMN, a message indicating whether the registration request is rejected or accepted, the message including SOR information and at least one of (i) a retention indication, (ii) a retention timer value, or (iii) a rejection cause; and registering with the VPLMN or selecting a new VPLMN in accordance with the received indication.

Another embodiment of these techniques is a UE comprising processing hardware and configured to implement the method above.

### BRIEF DESCRIPTION OF THE DRAWINGS

FIG. 1 is a block diagram of an example computing environment in which the SOR techniques of this disclosure can be implemented.

FIG. 2A illustrates an example scenario in which a UDM determines whether to accept or reject a registration attempt at a VPLMN by a roaming UE by obtaining SOR information from an SOR-AF via another service;

FIG. 2B is generally similar to that of FIG. 2A, but with the SOR-AF subscribing to event notifications from the HPLMN, and with the UDM requesting SOR information in accordance with the registration;

FIG. 3 is a flow diagram of an example method for processing SOR information at a node of the PLMN, operating as a Home PLMN for a roaming UE, and generating a notification for the UE related to the registration attempt;

FIG. 4 is a flow diagram of an example method for processing a registration accept message including SOR information, which can be implemented in a UE of this disclosure;

FIG. 5A is a flow diagram of an example method for processing a registration reject message including a reject cause and SOR information, which can be implemented in a UE of this disclosure;

FIG. 5B is a flow diagram of an example method for processing a registration reject message including a reject cause and a retention indication, which can be implemented in a UE of this disclosure;

FIG. 5C is a flow diagram of an example method for processing a registration reject message including a dedicated reject cause and a retention timer, which can be implemented in a UE of this disclosure; and

FIG. 6 illustrates an example scenario in which an SOR-AF provisions HPLMN with RVAS parameters.

### DETAILED DESCRIPTION OF THE DRAWINGS

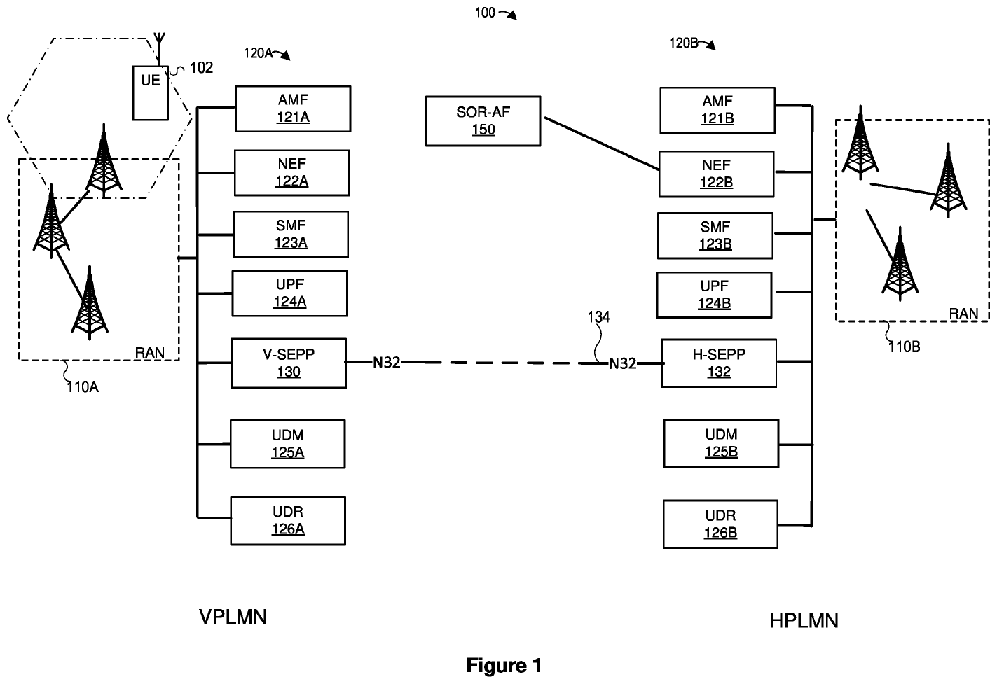

FIG. 1 illustrates an example computing environment 100 including a UE 102 communicating with a VPLMN 120A via a VPLMN RAN 110A including one or more base stations, and a HPLMN 120B. The SOR techniques of this disclosure can be implemented in the computing environment 100, briefly considered below.

The VPLMN 120A includes a core network with an Access and Mobility Management Function (AMF) 121A configured to manage authentication, registration, paging, and other related functions; a Network Exposure Function (NEF) 122A that allows to securely (e.g., via encryption and authentication mechanisms) expose the services of the 3GPP network functinos in the VLMN 120A; a Session Management Function (SMF) 123A configured to manage PDU sessions; a User Plane Function (UPF) 124A to transfer user-plane packets related to audio calls, video calls, Internet traffic; a Unified Data Management function (UDM) 125A configured to store and manage security credentials, subscription information, etc.; and a Unified Data Repository 126A which the UDM 125 can use to store and retrieve subscription data. The VPLMN 120A can also include other components that support various functions and services (omitted to reduce clutter). The HPLMN 120B in this example includes similar components, and in FIG. 1 these components are labeled with the same reference numbers and letter ‘B.’

The VPLMN 120A and the HPLMN 120B can communicate via a link 134. In particular, a Visitor Security Edge Protection Proxy (V-SEPP) 130 of the VPLMN 120A can securely communicate with a Home Security Edge Protection Proxy (H-SEPP) 132 of the HPLMN 120B via the link 134 using the N32 protocol.

Further, the HPLMN NEF 122B can communicate with an SOR-AF 150, which can operate independently of the HPLMN 120B as a third-party service, for example, and which the HLPMN NEF 122B can access via a network link. In another implementation, the SOR-AF 150 operate as a node in the core network of the HPLMN 120B.

In some implementations, the HPLMN 120B can support one or more northbound APIs (i.e., providing a lower-level network component access to a higher-level network component) to provide a redirection mechanism such that, similar to the redirection mechanism of a 4G network in which an entity could simply intercept and spoof inter-PLMN messaging, the UE 102 can receive a rejection cause that directs the UE to consider other VPLMNs, and without causing the UE 102 to reject the only available VPLMN (at least for the relevant service) and encounter a no-service condition. Thus, the HPLMN UDM 125B (or another suitable node of the HPLMN 120B) can selectively steer a roaming UE based on the information from the SOR-AF150.

For example, the UE 102 can receive a registration reject message with the cause value set to “PLMN not allowed,” “Requested service option not authorized in this PLMN,” or “Serving network not authorized.” If the UE 102 simply adds the rejected VPLMN to the list of forbidden PLMNs, usually implemented in the Universal Subscriber Identity Module (USIM), the UE 102 will not subsequently access the VPLMN in the automatic selection mode. However, when the SOR-AF 150 steers the UE 102 away from VPLMN₁ to VPLMN₂ during registration, the HPLMN 120B allows the UE 102 to still roam to VPLMN₁ if VPLMN₁ is the only available network rather than place the UE in a no-service situation.

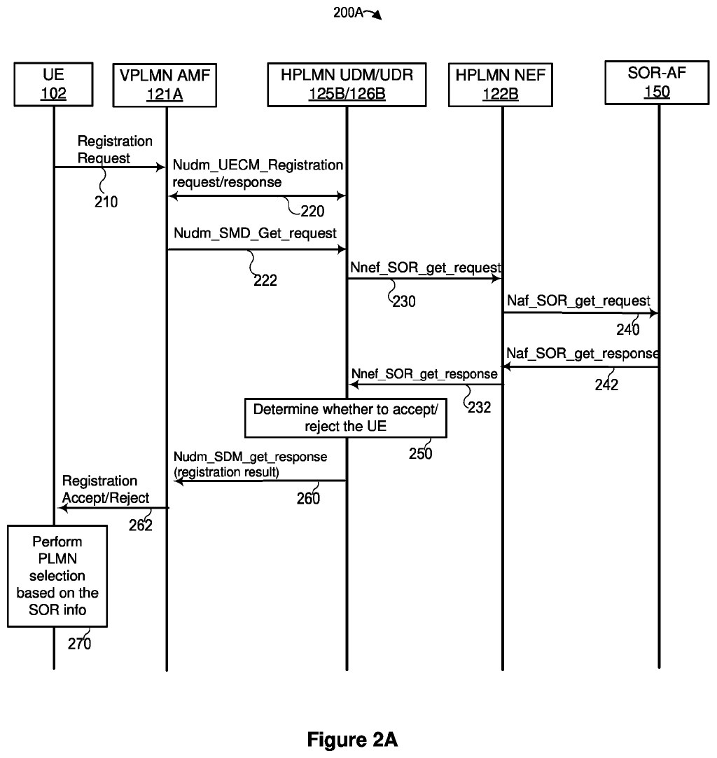

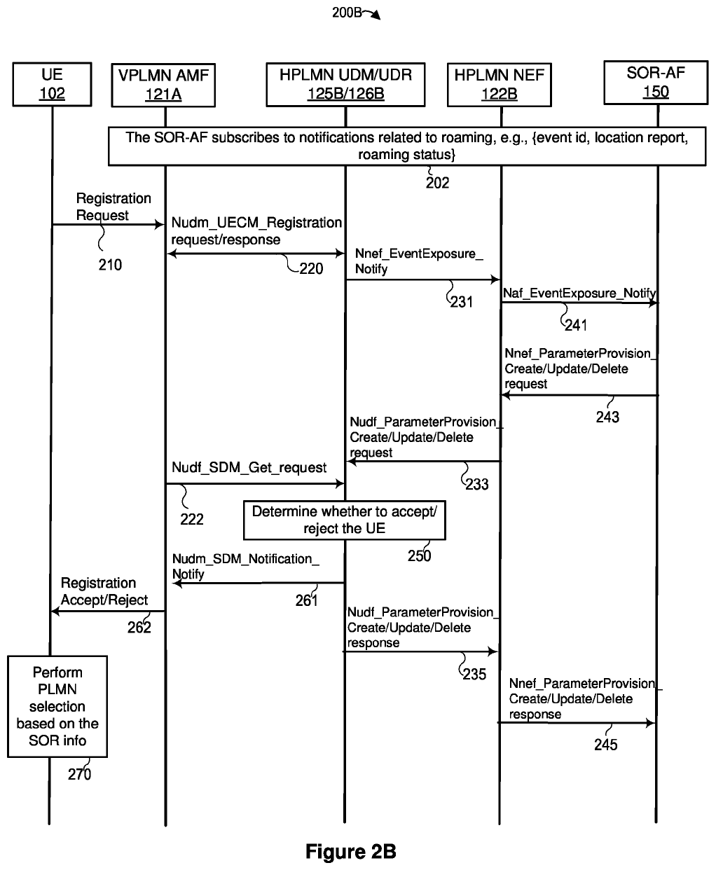

Now referring to FIG. 2A, in an example scenario 200A, the HPLMN UDM 125B and/or UDR 125B determines whether to accept or rejection an attempt of the UE 102 to register with the PLMN 120A, in view of the SOR information received from the SOR-AF 150A.

More particularly, the UE 102 transmits 210 a registration request 210 to the VPLMN AMF 121A. The VPLMN AMF 121A and the HPLMN UDM/UDR 125B/126B (for simplicity, “the UDM 126B”) exchange 220 initial messages related to the registration request and response, and the VPLMN AMF 121A performs 222 a Nudm_SDM_Get_request operation to request, from the HPLMN UDM 125B, access and mobility subscription data for the UE 102.

In response, the HPLMN UDM 125B performs 230 the Nnef_SOR_get_request operation to obtain, via the NEF 122B and from the SOR-AF 150, the SOR information for the UE 102 in relation to the VPLMN 120A. The NEF 122B sends 240 an Naf_SOR_get_request to the SOR-AF 150 and receives 242 a Naf_SOR_get_response from the SOR-AF 150. The NEF 122B then provides 232 to the Nnef_SOR_get_response to the UDM 125B.

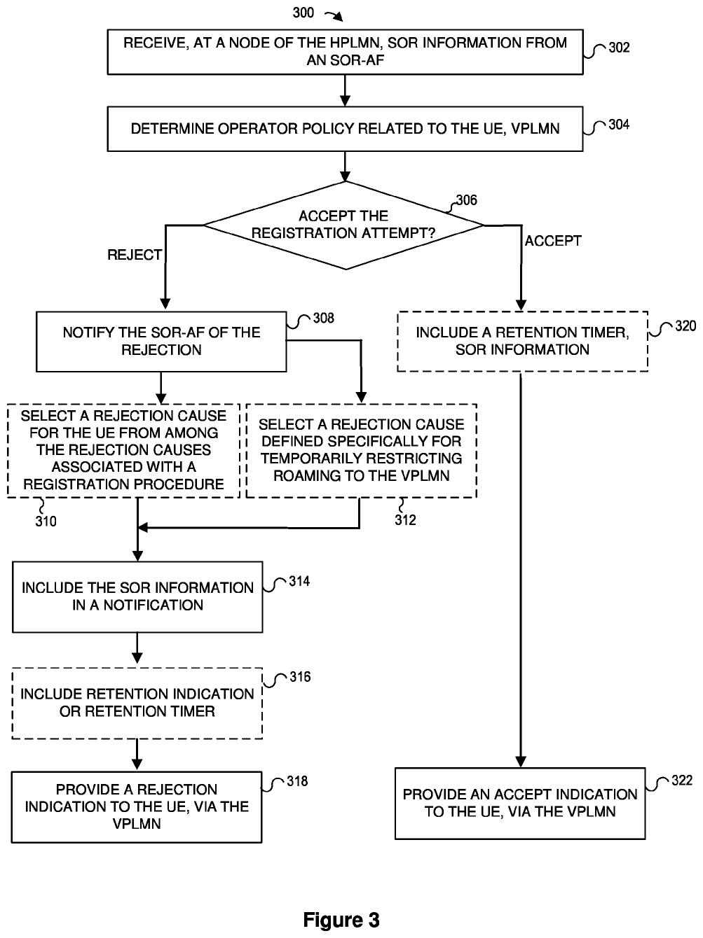

The UDM 125B determines 250 whether to accept or reject the registration attempt received 210 earlier, using the SOR information included in Nnef_SOR_get_response. In some cases, the UDM 125B also can use the policy of the HPLMN 125B. As discussed in more detail with reference to FIGS. 3-5C, the UDM 125B can specify a rejection cause that corresponds to a registration procedure or, in another implementation, is specifically defined to reject a registration attempt due to SOR. The HPLMN UDM/UDR 125B/126B in some cases also specifies a retention value and/or a retention timer, to prevent the UE from missing an opportunity to roam to the VPLMN 120A when no other networks are available. The UDM 125B then can specify 260 the registration result in a Nudm_SDM_Get_response operation. The UDM 125B also can provide 260 the SOR information to the VPLMN AMF 121A, as a part of the Nudm_SDM_Get_response operation.

The VPLMN AMF 121A then accepts or rejects 262 the registration request received 210 earlier and provides the rejection cause, a retention value, retention timer, etc. to the UE 102. In response, the UE 102 can perform the PLMN selection based on the SOR information. The UE 102 also can maintain a list of preferred PLMN/access technology combinations, which the UE 102 can update based on the SOR information and the outcome of the transmitted 210 registration attempt (accept, reject).

FIG. 2B illustrates a scenario 200B generally similar to the scenario 200A, but with the SOR-AF subscribing 202 to event notifications from the HPLMN 120B, and with the UDM 125B requesting SOR information in accordance with the registration. The differences between the scenarios 200A and 200B are discussed next.

The subscribing 202 procedure can involve the SOR-AF 150 invoking a northbound API exposed via the NEF 122B. The SOR-AF 150 can request 202 that the VPLMN 120A notify the SOR-AF 150 of the roaming status of UEs attempting to roam to the VPLMN 120A, provide location reports for the UEs, etc. After the UE 102 initiates 210 a registration request message, and the VPLMN AMF 121A notifies the HPLMN UDM 125B accordingly, the UDM 125B exchanges 220, 230 messages and determines 250 whether to accept or reject the UE as described with reference to FIG. 2A.

In response to the notification subscription 202, the UDM 125B notifies 231, 241 the SOR-AF 150 via the NEF 122B. The SOR-AF 150 applies 243,233 new SOR information, e.g. using a special-purpose procedure or the ParameterProvisioning procedure, for the UE 102 attempting to register with the VPLMN 120A. This procedure in some cases can trigger PLMN selection at the UE 102. In this case, the SOR-AF 150 can specify the VPLMN/RAT tuple as a preferred PLMN/RAT tuple and assigning the highest priority to the VPLMN/RAT. The UDM 125B then can provide 235,245 a response to the parameter provisioning or update procedure, via the NEF 122B.

FIGS. 3-5 provide flow diagrams for the HPLMN 120B, the VPLMN 120A, and the UE 102 to implement the SOR techniques described in FIGS. 2A and 2B. Each of these methods can be implemented as a set of instructions stored on a non-transitory computer-readable medium and executable by one or more processors.

FIG. 3 is a flow diagram of an example method for processing SOR information at a node of the PLMN, operating as a Home PLMN for a roaming UE, and generating a notification for the UE related to the registration attempt;

Referring first to FIG. 3, a UDM (e.g., the UDM 125B) or another suitable node can execute an example method 300 to processing SOR information generate a notification for the UE related to the registration attempt. Generally speaking, the UDM of this disclosure can determine whether to accept or reject a registration attempt of a UE based on (i) the operator's policy for the roaming UE, and for the registering PLMN (the VPLMN), and (ii) the message from the SOR-AF responsive to the request from the UDM.

In particular, at block 302, the UDM 125B can receive SOR information from an SOR-AF. The SOR is related to an attempt of a UE, for which the PLMN of the UDM operates as the HPLMN, to register at a VPLMN. Next, at block 304, the UDM can obtain operator policy related to the UE and/or the VPLMN. At block 306, the UDM uses the information obtained at blocks 302 and 305 to determine whether to accept or reject the registration attempt.

If the UDM determines to accept the request, the flow proceeds to block 320, where the UDM generates an accept indication or notification for the VPLMN and includes the SOR information and a retention timer value in the notification. In other implementations, however, the UDM omits the retention timer value, the SOR information, or both from the notification.

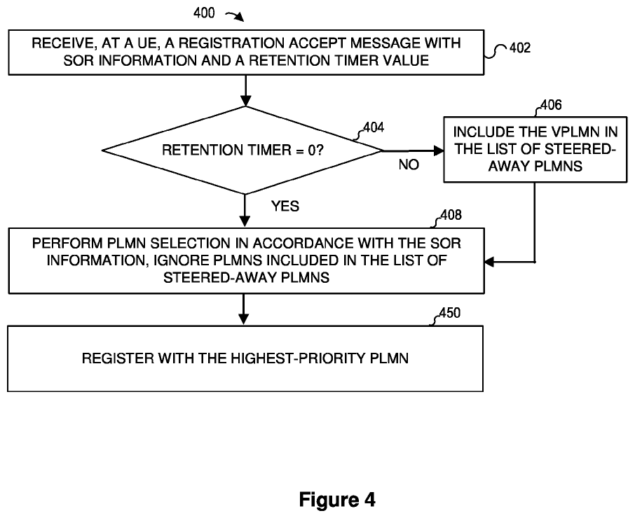

Including the retention timer at block 320 allows the HPLMN to temporarily suspend access to the VPLMN. The UE can re-attempt to register with the VPLMN, when necessary, after the time period corresponding to the retention timer value expires. In some cases, the UDM can set the retention timer value to zero. When the SOR information which the UDM includes in the accept notification pertains to the VPLMN, the UE can consider the VPLM a low-priority candidate for access (see FIG. 4). In accordance with TS 38.304, the UE can again select the VPLMN, depending on the cell selection procedure. As discussed below with reference to FIG. 4, when the retention timer is greater than zero, the UE can include the VPLMN in as list of steered-away PLMNs.

With continued reference to FIG. 3, the UDM can provide the accept indication to the UE, via the VPLMN, at block 322 (see events 260, 261).

If the UDM determines to reject the request, the flow proceeds from block 306 to block 308, where the UDM notifies the SOR-AF of the rejection. The flow then can proceed to block 310 or 312, depending on the implementation. At block 310, the UDM selects a rejection cause for the UE from among the rejection causes associated with a registration procedure. Thus, the UDM in this implementation uses the causes defined by previous 3GPP standards independently of the development of SOR techniques. Alternatively, at block 312, the UDM selects a rejection cause defined specifically for temporarily restricting roaming to the VPLM.

In any case, the flow proceeds to block 314, where the UDM includes the SOR information in the rejection indication or notification. At optional block 316, the UDM can include a retention indication or a retention timer in the rejection indication. At block 318, the UE provides the rejection indication to the UE, via the PLMN.

Processing of the SOR information, the rejection cause, the retention indication, and/or the retention timer is further discussed with reference to the UE methods 400 and 500A-C.

The method 400 of FIG. 4 begins at block 402, where the UE receives a registration accept message including SOR information and a retention timer value. If the UE determines that the retention timer is greater than zero, the flow proceeds to block 406, where the UE includes the VPLMN in a list of steered-away PLMNs. These VPLMNs are lower-priority networks to the UE for the purposes of roaming access. The UE can maintain this list in a memory or in the USIM, and in some cases can also store the corresponding timer retention values.

If, at block 404, the UE determines that the retention value is zero, the block proceeds to block 408. At block 408, the UE can perform the PLMN selection in accordance with the SOR information, and ignore the PLMNs included in the list of steered-away PLMNs, for which the corresponding retention timer is still running. When the SOR information received at block 402 pertains to the VPLMN, the UE can consider the VPLM a low-priority candidate for access. At block 450, the UE can register with a VPLMN having the highest priority.

Thus, the UE can use the retention timer to temporarily refrain from attempting to register with a PLMN to which the retention timer corresponds. When the retention timer expires, the UE removes the PLMN from the list of steered-away PLMNs.

When the UE is a legacy UE that does not recognize the retention timer, the UE will ignore the information element including the retention timer and operate as expected in accordance with the accept indication. The legacy UE can continue to apply the legacy SOR mechanism in accordance with the accept indication received at block 402.

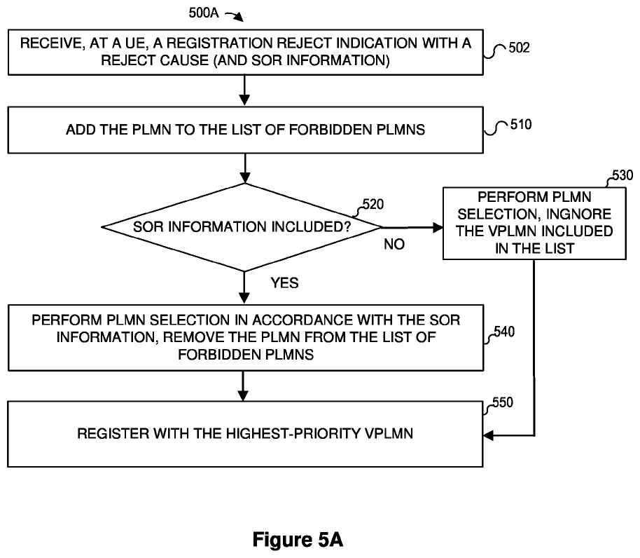

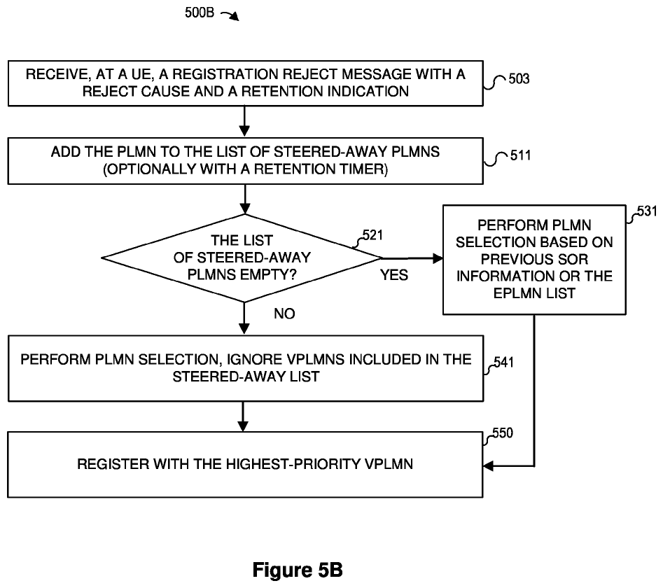

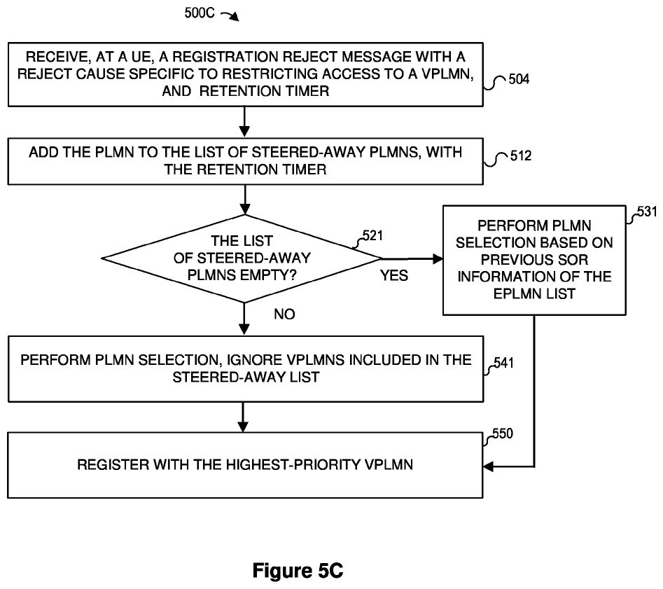

Now referring to FIG. 5A, an example method 500 for processing a registration reject message including a reject cause and SOR information can be implemented in the UE 102 or another suitable UE. At block 502, the UE receives a registration rejection indication or notification with a reject cause and, in some cases, SOR information, for a certain PLMN.

At block 510, the UE adds the PLMN to the list of forbidden PLMNs, which the UE can store in the memory or the USIM, similar to the list of steered-away PLMNs. A UE will not access a PLMN on the forbidden list except for disaster roaming services, in automatic mode, if the rejection indication includes a cause value “5GMM cause #11 (PLMN not allowed)” or “5GMM cause #73 (Serving network not authorized),” for example, or if the message in another implementation of the PLMN includes the cause value “5GMM cause #7 (5GS services not allowed.”

If the UE determines, at block 520, that the rejection indication does not include SOR information relevant to the PLMN, the flow proceeds to block 530, where the UE performs PLMN selection and ignores the PLMNs included in the list of forbidden PLMNs.

If the UE determines, at block 510, that the rejection indication includes SOR information relevant to the PLMN, the flow proceeds to block 540, where the UE performs PLMN selection in accordance with the SOR information and removes the PLMN from the list of forbidden PLMNs. At block 550, the UE can register with a VPLMN having the highest priority.

Referring in general to FIG. 5A, to avoid the no-services scenarios at the roaming UE, the UDM can update the UE with new SOR information during the registration reject procedure or subsequently to this procedure. The UE can remove the VPLMN from the list of forbidden PLMNs for 5GS service, or from the list of forbidden PLMNs (depending on the network implementation), if the SOR information includes VPLMN information. Thus, the SOR-AF and/or the UDM can generate the SOR information for the registration reject message either without the rejected VPLMN or with the VPLMN listed with a lower priority. If the registration reject message does not include SOR information, the UDM can update the SOR information when the UE performs a registration request for mobility update, or a periodic update, or after the UE successfully registers with another VPLMN.

Further, after receiving the registration rejection message, the UE performs PLMN selection based on an EPLMN list or the latest SOR information, if available, while considering the VPLMN as a lower-priority option but not forbidden for access. A legacy UE would not have a backward-compatibility issue because the UDM can use the same rejection cause. When the legacy UE does not recognize the SOR information in the registration reject message, the legacy UE can ignore the SOR information.

FIG. 5B illustrates an example method 500B for processing a registration reject message including a reject cause and a retention indication, which can be implemented the UE 102 or another suitable UE. At block 503, the UE receives a registration reject indication with a reject cause and a retention indication. At block 511, the UE adds the PLMN to the list of steered-away PLMNs, and in some cases includes the corresponding retention timers. If the UE 102 determines that the list of steered-away PLMNs is empty (block 521), the UE performs PLMN selection based on the previous SOR information or the EPLMN list (block 531). Otherwise, the UE performs PLMN selection and ignores PLMNs included in the steered-away list, at block 531. At block 550, the UE can register with a VPLMN having the highest priority.

Thus, the registration reject message in this implementation can include a rejection cause, a retention indication, and SOR information. The rejection cause can be for example “5GMM cause #11 (PLMN not allowed),” “5GMM cause #73 (Serving network not authorized),” or “5GMM cause #7 (5GS services not allowed).”

Here, with the rejection cause and retention indication, the UE includes the VPLMN in a list of steered-away PLMNs that were steered away and are considered to be of lower priority in the PLMN selection procedure, based on an EPLMN list or the latest SOR information (when available). When the UE performs PLMN selection, the UE ignores the PLMNs in the list of steered-away PLMNs.

Alternatively, the retention indication can be a retention timer value for the rejected VPLMN. The retention timer corresponds to a particular VPLMN and prevents the UE from selecting the VPLMN for a period of time. The UE maintains the retention timer of each PLMN in the list of steered-away PLMNs. When the retention timer of a PLMN expires, the UE removes the PLMN from the list of steered-away PLMNs. The UE however ignores the PLMN that has active retention timer running.

FIG. 5C is a flow diagram of an example method 500C for processing a registration reject message including a dedicated reject cause and a retention timer. At block 504, the UE receives a registration reject indication with a reject cause defined specifically for restricting access to a VPLMN, and a retention timer value. At block 512, the UE adds the PLMN to the list of steered-away PLMNs, and includes the corresponding retention timers. If the UE 102 determines that the list of steered-away PLMNs is empty (block 521), the UE performs PLMN selection based on the previous SOR information or the EPLMN list (block 531). Otherwise, the UE performs PLMN selection and ignores PLMNs included in the steered-away list, at block 531. At block 550, the UE can register with a VPLMN having the highest priority.

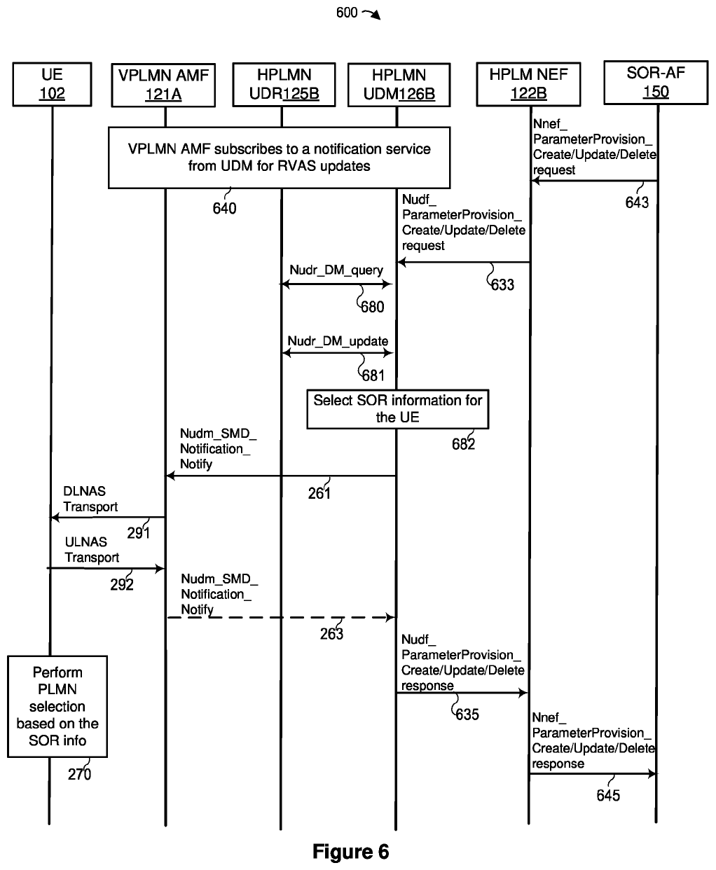

FIG. 6 illustrates an example scenario 600 in which an SOR-AF provisions HPLMN with RVAS parameters.

The VPLMN AMF 121A first subscribes 640 to Notification service from the UDM for the RVAS updates, which can be a part of a registration request procedure when the registration request at VPLMN is successful. The SOR-AF then determines to provision RVAS parameters including SOR information to UDM/UDR for Target UE Identifier using a dedicated procedure for RVAS or using a existing External Parameter Provisioning procedure (643, 633, 680, 681).

When the UDM/UDR receives 633 the new set of parameters for RVAS, the UDM selects 682 the SOR information that meets the validity criteria and provides 661 the selected SOR information to the VPLMN AMF in the Nudm_SDM_Notification request message.

If none of the conditions set by SOR-AF is met, the UDM can skip 661, 691, 692, and 663 and indicates 635, 645 the cause of failure provisioning in return message of Nnef_ParameterProvision_Create/Update/Delete response message in and Naf_ParameterProvision_Create/Update/Delecte response message to SOR-AF.

As further illustrated in FIG. 6, the UDM sends a notification message including selected SOR info to VPLMN AMF; the VPLMN AMF sends the selected SOR information to the UE via DL NAS Transport message; the UE may need to send ack message via UL NAS Transport message to AMF/UDM; the UDM further includes ack message and selected SOR information in return message of Nnef_ParameterProvision_Create/Update/Delete response message in step 10 and Naf_ParameterProvision_Create/Update/Delete response message in step 11 to SOR-AF; and the UE maintains the list of preferred PLMN/access technology combinations based on SOR information and registration accept or registration reject message accordingly. Then the UE performs PLMN selection based on EPLMN list or SOR information if available.

The following list of examples reflects a variety of the embodiments explicitly contemplated by the present disclosure:

Example 1. A method for supporting steering of roaming (SOR), implemented in a node of a core network (CN) of a Public Land Mobile Network (PLMN), the method comprising: receiving an indication of a registration attempt by a UE for which the PLMN operates as a home PLMN (HPLMN), the registration attempt occurring at a visitor PLMN (VPLMN); obtaining, from an entity configured to provide SOR information of the CN, SOR information related to the registration attempt; determining, based at least on the received response, whether to accept or reject the registration attempt; and providing, to the VPLMN, a result of the determining.

Example 2. The method of example 1, wherein obtaining the SOR information includes obtaining the SOR information from a SOR application function (SOR-AF).

Example 3. The method of example 2, further comprising: transmitting, to a Network Exposure Function (NEF) operating in the HPLMN, a request including an identifier of the VPLMN and an identifier of the UE.

Example 4. The method of example 3, wherein obtaining the SOR information includes: receiving, from the NEF, a response to the request, the response including the SOR information.

Example 5. The method of example 2, further comprising: determining that the entity subscribed to notifications from the HPLMN related to a roaming status of the UE; and in response to registration attempt, notifying the entity of the roaming status of the UE.

Example 6. The method of example 5, wherein notifying the entity of the roaming status of the UE includes transmitting a notification via an NEF.

Example 7. The method of example 6, wherein obtaining the SOR information from the entity includes: in response to transmitting the notification, receiving the SOR information from the entity, via the NEF.

Example 8. The method of any of examples 5-7, wherein obtaining the SOR information includes performing a parameter provisioning procedure with the entity.

Example 9. The method of any of the preceding examples, wherein determining whether to accept or reject the registration attempt includes: determining an operator policy related to the UE and the VPLMN; and determining whether to accept or reject the registration attempt based on the operator policy and the received response from the entity.

Example 10. The method of any of the preceding examples, further comprising: in response to determining to accept the registration attempt, providing, to the UE via the VPLMN, the SOR information.

Example 11. The method of example 10, further including: providing, to the UE via the VPLMN, a retention timer value specifying a period of time during the UE is to refrain from registering with the VPLMN.

Example 12. The method of example 11, including setting the retention timer to zero in response to determining that the operator policy does not preclude immediate registration of the UE with the VPLMN.

Example 13. The method of any of examples 1-9, further comprising: in response to determining to reject the registration attempt, providing, to the VPLMN, (i) a rejection cause selected from among a plurality of cause values specified for a registration procedure, and (ii) the SOR information received from the entity.

Example 14. The method of any of examples 1-9, further comprising: in response to determining to reject the registration attempt, providing, to the VPLMN, (i) a rejection cause selected from among a plurality of cause values specified for a registration procedure, (ii) the SOR information received from the entity, and (iii) a retention indication to direct the UE to retain the VPLMN in a list of steered-away, lower-priority VPLMNs.

Example 15. The method of any of examples 1-9, further comprising: in response to determining to reject the registration attempt, providing, to the VPLMN, (i) a rejection cause selected from among a plurality of cause values specified for a registration procedure, (ii) the SOR information received from the entity, and (iii) a retention timer value to direct the UE to keep the VPLMN in a list of steered-away, lower-priority VPLMNs for a specified period of time.

Example 16. The method of any of examples 1-9 or 12, further comprising: in response to determining to reject the registration attempt, providing, to the VPLMN, (i) a rejection cause defined specifically for a temporary restriction of roaming to the VPLMN, (ii) the SOR information received from the entity, and (iii) a retention timer value to direct the UE to keep the VPLMN in a list of steered-away, lower-priority VPLMNs for a specified period of time.

Example 17. The method of any of examples 13-16, further comprising: in response to determining to reject the registration attempt, notifying the entity that the registration attempt for the UE at the VPLMN is rejected.

Example 18. The method of any of the preceding examples, wherein the SOR-AF operates as a third-party service, independent of the HPMN.

Example 19. The method of any of the preceding examples, wherein the SOR-AF operates as a service within the HPMN.

Example 20. The method any of the preceding examples, wherein the node is a Unified Data Management node (UDM).

Example 21. A network node comprising processing hardware and configured to implement a method according to any of the preceding examples.

Example 22. A method in a UE associated with an HPLMN for registering with a VPLMN, the method comprising: transmitting, to the VPLMN, a registration request; receiving, via the PLMN, a message indicating whether the registration request is rejected or accepted, the message including SOR information and at least one of (i) a retention indication, (ii) a retention timer value, or (iii) a rejection cause; and registering with the VPLMN or selecting a new VPLMN in accordance with the received indication.

Example 23. The method of example 22, wherein: the message indicates that the registration request is accepted; and the message includes the retention timer value.

Example 24. The method of example 23, further comprising: in response to determining that the retention timer value is non-zero, adding the VPLMN to a list of steered-away PLMNs, wherein registering with the VPLMN or selecting the new VPLMN includes refraining from attempting to register with any PLMN included in the list of steered-away PLMNs.

Example 25. The method of example 23, further comprising: in response to determining that the retention timer value is zero, excluding the VPLMN from a list of steered-away PLMNs, wherein registering with the VPLMN or selecting the new VPLMN includes refraining from attempting to register with any PLMN included in the list of steered-away PLMNs.

Example 26. The method of example 22, wherein: the message indicates that the registration request is rejected; and the message including the reject cause selected from among a plurality of cause values specified for a registration procedure.

Example 27. The method of example 22, wherein: the message indicates that the registration request is rejected; and the message including the reject cause defined specifically for a temporary restriction of roaming to the VPLMN.

Example 28. The method of example 26 or 27, further comprising: adding the VPLMN to a list of forbidden PLMNs; and in response to determining that the SOR information pertains to the VPLMN, removing from the VPLN from the list of forbidden PLMNs, wherein the UE refrains from attempting to register with any PLMN included in the list of forbidden PLMNs.

Example 29. The method of example 26 or 27, further comprising: adding the VPLMN to a list of forbidden PLMNs; and in response to determining that the SOR information does not pertain to the VPLMN, maintaining the VPLN in the list of forbidden PLMNs, wherein the UE refrains from attempting to register with any PLMN included in the list of forbidden PLMNs.

Example 30. The method of example 22, wherein: the message indicates that the registration request is rejected; and the message includes the retention indication.

Example 31. The method of example 30, further comprising: adding the VPLMN to a list of steered-away PLMNs.

Example 32. A UE comprising processing hardware and configured to implement a method according to any of examples 22-31.

### Additional Considerations

The following additional considerations apply to the foregoing discussion.

A client device in which the techniques of this disclosure can be implemented (e.g., the client device 102) can be any suitable device capable of wireless communications such as a smartphone, a tablet computer, a laptop computer, a desktop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the client device in some cases may be embedded in an electronic system such as the head unit of a vehicle or an advanced driver assistance system (ADAS). Still further, the client device can operate as an internet-of-things (IoT) device or a mobile-internet device (MID). Depending on the type, the client device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

What is claimed is:

1. A method for supporting steering of roaming (SOR), implemented in a node of a core network (CN) of a Public Land Mobile Network (PLMN), the method comprising:
receiving an indication of a registration attempt by a UE for which the PLMN operates as a home PLMN (HPLMN), the registration attempt occurring at a visitor PLMN (VPLMN);
obtaining, from an entity configured to provide SOR information of the CN, SOR information related to the registration attempt;
determining, based at least on the received SOR information and an operator policy related to the UE and the VPLMN, whether to accept or reject the registration attempt; and
providing, to the VPLMN, a result of the determining.

2. The method of claim 1, further comprising:
transmitting, to a Network Exposure Function (NEF) operating in the HPLMN, a request including an identifier of the VPLMN and an identifier of the UE.

3. The method of claim 1 or 2, further comprising:
determining that the entity subscribed to notifications from the HPLMN related to a roaming status of the UE; and
in response to the registration attempt, notifying the entity of the roaming status of the UE.

4. The method of claim 3, wherein the obtaining of the SOR information from the entity includes:
in response to the notifying the entity of the roaming status of the UE via the NEF, receiving the SOR information from the entity, via the NEF.

5. The method of any of claims 1-4 claim 10, further including:
providing, to the UE via the VPLMN, a retention timer value specifying a period of time during the UE is to refrain from registering with the VPLMN.

6. The method of claim 5, including setting the retention timer to zero in response to determining that the operator policy does not preclude immediate registration of the UE with the VPLMN.

7. The method of any of claims 1-4, further comprising:
in response to determining to reject the registration attempt, providing, to the VPLMN, one or more of:
(i) a rejection cause selected from among a plurality of cause values specified for a registration procedure,
(ii) the SOR information received from the entity, or
(iii) a retention indication to direct the UE to retain the VPLMN in a list of steered-away, lower-priority VPLMN.

8. A method in a UE associated with an HPLMN for registering with a VPLMN, the method comprising:
transmitting, to the VPLMN, a registration request;
receiving, via the VPLMN, a message indicating whether the registration request is rejected or accepted, the message including SOR information and at least one of (i) a retention indication or (ii) a retention timer value; and
registering with the VPLMN or selecting a new VPLMN in accordance with the received indication.

9. The method of claim 8, wherein:
the message indicates that the registration request is accepted; and
the message includes the retention timer value; and
in response to determining that the retention timer value is non-zero, adding the VPLMN to a list of steered-away PLMNs,
wherein registering with the VPLMN or selecting the new VPLMN includes refraining from attempting to register with any PLMN included in the list of steered-away PLMNs.

10. The method of claim 8, wherein:
the message indicates that the registration request is accepted; and
the message includes the retention timer value; the method further comprising:
in response to determining that the retention timer value is zero, excluding the VPLMN from a list of steered-away PLMNs,
wherein registering with the VPLMN or selecting the new VPLMN includes refraining from attempting to register with any PLMN included in the list of steered-away PLMNs.

11. The method of claim 8, wherein:
the message indicates that the registration request is rejected; and
the message includes a rejection cause selected from among a plurality of cause values specified for a registration procedure.

12. The method of claim 8, wherein:
the message indicates that the registration request is rejected; and
the message includes a rejection cause defined specifically for a temporary restriction of roaming to the VPLMN.

13. The method of claim 11 or 12, further comprising:
adding the VPLMN to a list of forbidden PLMNs; and
in response to determining that the SOR information pertains to the VPLMN, removing from the VPLMN from the list of forbidden PLMNs,
wherein the UE refrains from attempting to register with any PLMN included in the list of forbidden PLMNs.

14. The method of claim 11 or 12, further comprising:
adding the VPLMN to a list of forbidden PLMNs; and
in response to determining that the SOR information does not pertain to the VPLMN, maintaining the VPLMN in the list of forbidden PLMNs,
wherein the UE refrains from attempting to register with any PLMN included in the list of forbidden PLMNs.

15. An apparatus comprising processing hardware and configured to implement a method according to any of the preceding claims.
